(19) United States
(12) Patent Application Publication
(10) Pub. No.: US 2015/0109700 A1
(43) Pub. Date: Apr. 23, 2015

(54) SHINGLED MAGNETIC RECORDING SYSTEM WITH ADAPTIVE WRITE BUFFER AREA

(71) Applicant: HGST Netherlands B.V., Amsterdam (NL)

(72) Inventors: Hidekazu KASHIWASE, Yokohama-shi (JP); Hiroyasu TANABE, Yokohama-shi (JP); Hideki ZAITSU, Fujisawa-shi (JP)

(73) Assignee: HGST Netherlands B.V., Amsterdam (NL)

(21) Appl. No.: 14/057,557

(22) Filed: Oct. 18, 2013

(51) Int. Cl. G11B 5/596

(52) U.S. Cl. CPC G11B 5/596; G11B 5/59627
USPC 360/77.04; 360/77.02

(57) ABSTRACT

Techniques for writing data to a buffer region of a magnetic disk are described. In one example, a hard disk drive comprises a magnetic disk comprising a data buffer region including a first zone and a second zone. Data may be written to the magnetic disk using shingled magnetic recording (SMR) and the buffer region may be an exception region (E-region). A hard disk drive may be configured to calculate a position accuracy value associated with a data writing head. The hard disk drive may select one of the zones based on the position accuracy value. Further, a selected zone may have a determined zone format. The hard disk drive may be configured to write data to the selected zone using the determined zone format.

### TECHNICAL FIELD

This disclosure relates to data storage devices, and more particularly to techniques for optimizing capacity and the data transfer rates of a storage device.

### BACKGROUND

Data storage devices can be incorporated into a wide range of devices, including large scale data centers, laptop or desktop computers, tablet computers, digital video recorders, set-top boxes, digital recording devices, digital media players, video gaming devices, video game consoles, cellular telephones, and the like. Data storage devices may include hard disk drives (HDD). HDDs include one or multiple magnetic disks having positive or negative areas of magnetization. Bits of data may be represented using the positive and negative areas of magnetization. Blocks of data are arranged to form tracks on a rotating disk surface. A magnetic transducer may be used to read data from the disk and write data to a disk. Different magnetic recording techniques may be used to store data to the disk. Magnetic recording techniques include, for example, longitudinal magnetic recording (LMR), perpendicular magnetic recording (PMR), and shingled magnetic recording (SMR). Heat assisted magnetic recording (HAMR) may be used with LMR, PMR, or SMR.

During operation, the disk of a HDD may be subjected to vibrations caused by normal operation of the disk or by ambient conditions. In some cases, ambient conditions may introduce severe vibrations that inhibit the ability of a HDD to properly perform read and/or write operations and data transfer rates may degrade.

### SUMMARY

In general, this disclosure describes techniques for writing data to a storage medium. In particular, this disclosure describes techniques for defining areas of a storage disk and adaptively writing data to areas of the storage disk. The techniques of this disclosure may be particularly useful for selecting an area within a write buffer area, including an E-region of an SMR disk, to write data to.

According to one example of the disclosure, a method of writing data to a buffer region of a shingled magnetic recording disk, comprises calculating a position accuracy value associated with a data writing head, selecting one of a first zone and a second zone of the buffer region based on the position accuracy value, wherein the first zone includes an initial track density that is greater than an initial track density of the second zone, and writing data to the selected zone.

According to another example of the disclosure, a shingled magnetic disk comprises a data buffer region including a first zone and a second zone, wherein the first zone includes an initial track density that is greater than an initial track density of the second zone and a processing unit configured to calculate a position accuracy value associated with a data writing head, select one of a first zone and a second zone of the buffer region based on the position accuracy value, and write data to the selected zone.

According to another example of the disclosure a non-transitory computer-readable storage medium has instructions stored thereon that upon execution cause one or more processors of a hard disk drive to calculate a position accuracy value associated with a data writing head, select one of a first zone and a second zone of a buffer region of a shingled magnetic disk based on the position accuracy value, wherein the first zone includes an initial track density that is greater than an initial track density of the second zone, and write data to the selected zone.

According to another example of the disclosure, an apparatus for writing data to a buffer region of a magnetic disk comprises means for calculating a position accuracy value associated with a data writing head, means for selecting one of a first zone and a second zone of the buffer region based on the position accuracy value, wherein the first zone includes an initial track density that is greater than an initial track density of the second zone, and means for writing data to the selected zone.

The details of one or more examples are set forth in the accompanying drawings and the description below. Other features, objects, and advantages will be apparent from the description and drawings, and from the claims.

### BRIEF DESCRIPTION OF DRAWINGS

FIG. 1 is a conceptual diagram illustrating an example hard disk drive that may utilize the techniques described in this disclosure.

FIG. 2 is a conceptual diagram illustrating an example of a plurality of zones within a region of a disk.

FIG. 3 is a block diagram illustrating an example error correction unit that may utilize techniques described in this disclosure.

FIG. 4 is a conceptual diagram illustrating one example of determining a track density according to techniques described in this disclosure.

FIG. 5 is a block diagram illustrating an example zone format selector that may utilize techniques described in this disclosure.

FIG. 6 is a flowchart illustrating an example method for writing data to a magnetic disk according to the techniques of this disclosure.

### DETAILED DESCRIPTION

In general, this disclosure describes techniques for writing data to a storage medium. In particular, this disclosure describes a disk with different areas. The different areas of the disk may be included within a designated write buffer area of a disk. A designated write buffer area of a disk may be an E-region of a SMR disk. Techniques described in this disclosure may be used for selecting an area of the disk to write data. Data may be written to each area of the disk using one or more of a respective track pitch, track density, and/or write inhibit value.

Disks of hard disk drives (HDD) may be subjected to vibrations caused by normal operation of the disk drive or by ambient conditions. For example, an HDD may be coupled to a device with speakers that introduce severe vibrations. Vibrations may reduce the ability of a write head to accurately maintain an alignment with respect to a track of a disk. Severe vibrations may cause Track Mis-Registration (TMR) and a HDD may not be able to perform write operations due to TMR.

In some cases, HDD disks are designed to accommodate predictable vibrations caused by normal operations. However, accommodating less predictable severe vibrations caused by ambient conditions is more difficult. In some cases, a HDD may repeatedly retry a write operation until a time when vibrations are reduced such that a write operation can be performed. However, write operation retries may cause data transfer rates to deteriorate greatly during prolonged periods of vibration. Further, in some cases, a write operation may time-out after a number of unsuccessful write retries. In other cases, a HDD may write data to a disk using relatively greater track densities at inner diameters in order to achieve a consistent TMR rate across the disk based on predicted operating conditions. However, such HDDs may not adequately address severe vibrations that occur outside of the predicted operating conditions and if track densities are based on worst case conditions, capacity may be limited. Further, such HDDs may not be configured to adaptively perform write operations based on vibrations that are actually being experienced by the HDD.

Some HDD disks include a data buffering or staging area where data is written before the data is written to another area of disk. For example, disks where tracks are shingled, such as shingled magnetic recording (SMR) disks, may include a data buffering region (e.g., an E-region) and a regular data storage region (e.g., an I-region). Data may be initially written to an E-region and then written to an I-region. Vibrations caused during write operations associated transferring data from a data buffer may be especially problematic due to the relatively limited amount of disk storage capacity reserved for data buffering (e.g., vibrations may result in buffer overflows). In view of the above, this disclosure provides techniques for adaptively writing data to defined areas of a magnetic disk based on determined vibration conditions. While the techniques of this disclosure may be particularly useful for a HDD including a SMR disk with a write buffer area, the techniques described herein may be readily applied to other types of HDDs as well.

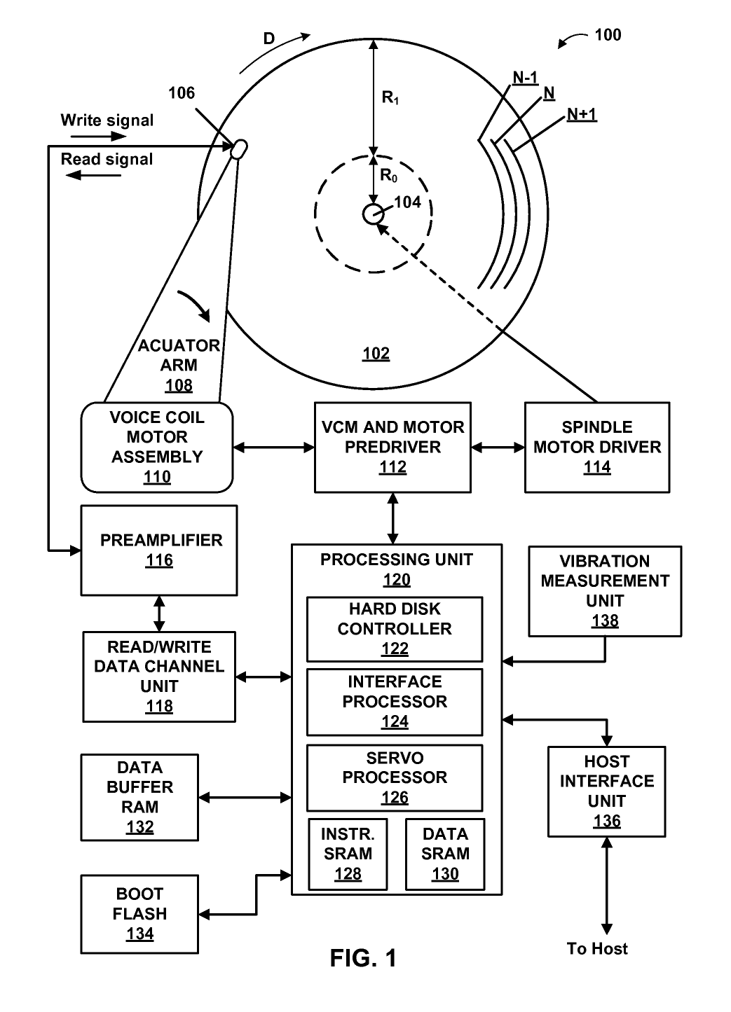

FIG. 1 is a conceptual diagram illustrating an example hard disk drive that may utilize the techniques described in this disclosure. Hard disk drive 100 may be operably coupled to a host device as an internal or an external data storage device. A host device may include, for example, a laptop or desktop computer or a similar device. Hard disk drive 100, includes data recording disk or medium 102, spindle assembly 104, slider 106, actuator arm 108, voice coil motor assembly 110, VCM and motor predriver 112, spindle motor driver 114, preamplifier 116, read/write data channel unit 118, processing unit 120, data buffer RAM 132, boot flash 134, host interface unit 136, and vibration measurement unit 138. Further, processing unit 120 includes hard disk controller 122, interface processor 124, servo processor 126, instruction SRAM 128, and data SRAM 130. It should be noted that although example hard disk drive 100 is illustrated as having distinct functional blocks, such an illustration is for descriptive purposes and does not limit hard disk drive 100 to a particular hardware architecture. In a similar manner, processing unit 120 should not be limited to a particular hardware architecture based on the example illustrated in FIG. 1. Functions of hard disk drive 100 may be realized using any combination of hardware, firmware and/or software implementations.

Disk 102 includes a stack of one or more disks having magnetic material deposited on one or both sides thereof. Disk 102 may be composed of a light aluminum alloy, ceramic/glass, or other suitable substrate that magnetic material may be deposited thereon. Using electromagnetic techniques, data may be stored on disk 102 by orientating an area of the magnetic material. Data stored on disk 102 may be organized as data blocks. Data blocks are typically 512 bytes or 4 KB in size, but may be other sizes as well. The magnetic areas of disk 102 may be arranged into a set of radially-spaced concentric tracks, illustrated in FIG. 1 as N−1, N, and N+1. A particular data block may be located within a sector of a particular track.

Magnetic material of disk 102 may be configured according to one of a plurality of magnetic recording techniques. Examples of magnetic recording techniques include longitudinal magnetic recording (LMR) and perpendicular magnetic recording (PMR). Additional magnetic recording techniques include shingled magnetic recording (SMR) and heat assisted magnetic recording (HAMR). SMR is a type of PMR that increases bit density compared to conventional PMR by allowing tracks to be written in a manner that allows overlap of one or more adjacent tracks. HAMR may be used in conjunction with LMR, PMR, or SMR techniques to achieve higher areal storage density.

The bit density, distance between tracks (referred to as track pitch), and track density of disk 102 may vary according to a magnetic recording technique. Track density may be defined according to the number of tracks per radial length (e.g., track per inch (TPI)). Track pitch may be defined as a target or nominal distance between tracks. Further, as illustrated in FIG. 1, disk 102 may be configured to include plurality of regions, i.e., R₀, and R₁. Data may be recorded to each of R₀ and R₁ using different track densities and track pitches. For example, in some cases it may be easier, mechanically, for hard disk drive 100 to write data to disk 102 at higher track densities at radial distances further from the center of disk 102. Thus, in one example hard disk drive 100 may be configured to write data to R₁ using a track density which is greater than the track density used to write data to R₀. Each region may include a plurality of zones defined according to a number of radially adjacent tracks (which may be referred to as a band) or according to a radial distance. Each of the zones within a region may use different track densities and track pitches for storing data.

In one example, disk 102 is configured to store data using SMR. In contrast to conventional PMR tracks, which can be written in any order, shingled tracks are written according to a particular sequence. The tracks of an SMR disk are typically organized into a plurality of shingled regions (referred to as I-regions) in which tracks are written sequentially from an inner diameter (ID) to an outer diameter (OD) or in some examples, from OD to ID. In order to improve the performance of SMR disks, a portion of the disk may be allocated to a so-called “exception region” (i.e., E-region, which may also be referred to as write buffer area or E-cache).

An E-region may be used as a staging area for data which will ultimately be written to an I-region. An E-region may be configured to have either shingled or unshingled tracks. It should be noted that in some examples, hard disk drive 100 may include a so-called hybrid E-region where a hybrid E-region includes areas of disk 102 and portion data SRAM 130 which may be used by hard disk drive 100 for data staging. Typically, only a minor portion of a disk's area is an E-region (e.g., 5%-10%). In one example, R₀ of disk 102 may be an E-region and R₁ of disk 102 may be an I-region. In other examples, disk 102 may include multiple I-regions and multiple E-regions where I-regions and E-regions are located at various radial positions of disk 102 (e.g., disk 102 may include concentric circular bands of E-regions and I-regions). Further, as described above, disk 102 may include multiple disks. Thus, particular E-regions and I-regions need not be included on the same disk (e.g. an E-region may be located on a first disk and an I-region may be located on a second disk). Further, it should be noted that although not shown disk 102 may include other types of regions including, for example, guard regions and write-twice cache regions. It should be noted that other types of magnetic recording techniques may incorporate techniques that allocate areas of a disk to be used as a write buffer area. Thus, disk 102 may be configured according to any combination of magnetic recording techniques where R₀ or R₁ is a write buffer area of a magnetic disk 102 and the other area is the area where data is ultimately written.

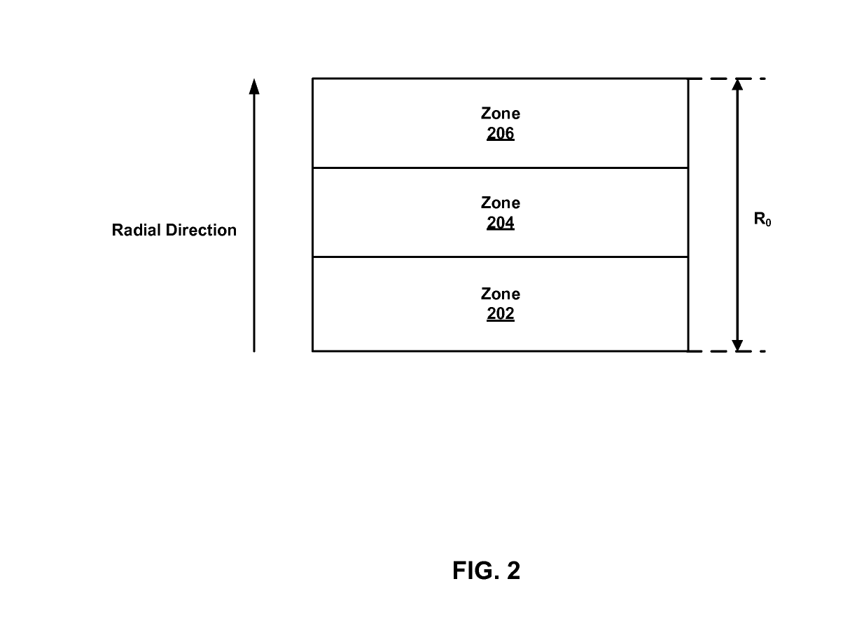

As described above, a region may include a plurality of zones defined according to a number of radially adjacent tracks or according to a radial distance. FIG. 2 is a conceptual diagram illustrating an example of a plurality of zones within a region of a disk. In the example illustrated in FIG. 2, R₀ includes zone 202 located at a radial distance relatively closer to the center of disk 102 and zone 204 and zone 206 located radial distances respectively further from the center of disk 102. As described above, R₀ may be an E-region of a disk configured to use SMR. Thus, in the example illustrated in FIG. 2, each of zone 202, zone 204, and zone 206 may be zones within an E-region. As described in greater detail below, a position accuracy value associated with a data writing head may be used to select one of zone 202, zone 204, and zone 206 to write data to. Further, each of zone 202, zone 204, and zone 206 may be adaptively formatted using different zone formats (e.g., track densities, track pitches, and/or write inhibit values (winh)) based on a position accuracy valued associated with a data writing head.

As described above, data stored on disk 102 may be organized as data blocks. In some examples, address indirection may be used to write blocks of data to disk 102. That is, host file systems may use logical block addresses (LBAs) in commands to read and write blocks of data to disk 102 without regard for actual locations (physical block address (PBA)) used internally by hard disk drive 100. Address indirection may be particularly useful to shield a host from the complexities associated with SMR. As described in detail below, address indirection is typically implemented in the controller portion of the drive's architecture (e.g., hard disk controller 122) using indirection tables.

Referring again to FIG. 1, disk 102 is coupled to spindle assembly 104 and rotates in direction D about a fixed axis of rotation. Disk 102 may be rotated at a constant or varying rate. Typical rates of rotation range from less than 3,600 to more than 15,000 revolutions per minute. However, disk 102 may be rotated at higher or lower rates and the rate of rotation may be determined based on a magnetic recording technique. Spindle assembly 104 includes a spindle and a motor and is coupled to spindle motor driver 114. Spindle motor driver 114 provides an electrical signal to spindle assembly 104 and the rate at which the spindle rotates, and thereby disk 102, may be proportional to the voltage or current of the electrical signal. Spindle motor driver 114 is coupled to VCM and motor predriver 112. VCM and motor predriver 112 may be configured to use feedback techniques to insure disk 102 rotates as a desired rate. For example, VCM and motor predriver 112 may be configured to receive current and/or voltage signals from the motor for example and adjust the electrical signal provided to spindle motor driver 114 using feedback circuits.

As illustrated in FIG. 1, VCM and motor predriver 112 is also coupled to voice coil motor assembly 110. In addition to providing an electrical signal to spindle motor driver 114, VCM and motor predriver 112 is also configured to provide an electrical signal to voice coil motor assembly 110. Voice coil motor assembly 110 is operably coupled to actuator arm 108 such that actuator arm 108 pivots based on the current or voltage of the electrical received from signal VCM and motor predriver 112. As illustrated in FIG. 1, slider 106 is coupled to actuator arm 108. Thus, VCM and motor predriver 112 adjusts the position of slider 106 with respect to disk 102. VCM and motor predriver 112 may use feedback techniques to ensure slider 106 maintains a desired position with respect to disk 102. In one example, VCM and motor predriver 112 includes an analog-to-digital converter to monitor electromagnetic fields and current from voice coil motor assembly 110.

Slider 106 is configured to read and write data to disk 102 according to a magnetic recording technique, for example, any of the example magnetic recording techniques described above. Slider 106 may include read and write heads corresponding to each of a plurality of disks included as part of disk 102. Further, slider 106 may include one or more read and write heads for each disk. Slider 106 is coupled to preamplifier 116. Preamplifier 116 may also be referred to as arm electronics (AE). Preamplifier 116 is configured to select a correct head from a plurality of heads for a particular read or write operation. Preamplifier 116 is configured to drive head 106 with a write current, during a write operation. Further, preamplifier 116 is configured to amplify read signals from slider 106, during a read operation using a programmable head bias current. Preamplifier 116 may also be configured to detect errors during each of the read and write operations. Preamplifier 116 may include a signal adaptive filter (SAF) for thermal asperity (TA) recovery during a read operation.

Preamplifier 116 receives data to be written to disk 102 from read/write data channel unit 118. Further, preamplifier 116 provides data read from disk 102 to read/write data channel unit 118. Data may originate from a host device and may be communicated to read/write data channel unit 118 via host interface unit 136 and processing unit 120. Host interface unit 136 provides a connection between hard disk drive 100 and a host device. Host interface unit 136 may operate according to a physical and logical characteristics defined according to a computer bus interface. Example standardized interfaces include ATA (IDE, EIDE, ATAPI, UltraDMA, SATA), SCSI (Parallel SCSI, SAS), Fibre Channel, and PCIe (with SOP or NVMe).

As illustrated in FIG. 1, processing unit 120 includes hard disk controller 122, interface processor 124, servo processor 126, instruction SRAM 128, and data SRAM 130. Instruction SRAM 128 may store a set of operation instructions for processing unit 120. Instructions may be loaded to instruction SRAM 128 from boot flash 134 when hard disk drive 100 is powered on. Data SRAM 130 and data buffer RAM 132, which is coupled to processing unit 120 are configured to buffer blocks of data during read and write operations. For example, blocks of data received from host interface unit 136 may be sequentially stored to data SRAM 130 and data buffer RAM 132 before the data blocks are written to disk 102. It should be noted that although instruction SRAM 128, data SRAM 130, data buffer RAM 132, and boot flash 134 are illustrated as distinct memory units, the functions of instruction SRAM 128, data SRAM 130, data buffer RAM 132, and boot flash 134 may be implemented according to other types of memory architectures.

Hard disk controller 122 generally represents the portion of processing unit 120 configured to manage the transfer of blocks of data to and from host interface unit 136 and read/write data channel unit 118. Hard disk controller 122 may be configured to perform operations to manage data buffering and may interface with host interface unit 136 according to a defined computer bus protocol, as described above. For example, hard disk controller 122 may receive and parse packets of data from host interface unit 136. Further, hard disk controller 122 may be configured to communicate with host. For example, hard disk controller 122 may be configured to report errors to host and format disk 102 based on commands received from host.

As described above, hard disk controller 122 may be configured perform address indirection. That is hard disk controller 122 may translate the LBAs in host commands to an internal physical address, or an intermediate address from which a physical address can ultimately be derived. It should be noted in for a hard disk drive that utilizes SMR the physical block address (PBA) of a logical block address (LBA) can change frequently. Further, for an SMR hard disk drive, the LBA-PBA mapping can change with every write operation because the hard disk drive may dynamically determine the physical location on the disk where the data for an LBA will be written. Further, the data for the same LBA may be written to a different location the next time the host LBA is updated. In addition, a hard disk drive, such as hard disk drive 100, may autonomously move data between write caches in RAM, write caches on disk 102, E-regions on disk 102 and I-regions on disk 102. In some examples, the LBAs for the data may stay the same regardless of where the hard disk drive 100 has the data stored. Further, background processes, such as, for example, defragmentation may also be executed autonomously by hard disk drive 100 to move data sectors from one PBA to another while the LBA stays the same. Thus, hard disk drive 102 may be configured to use address indirection in associated with multiple types of write operations.

Interface processor 124 generally represents the portion of processing unit 120 configured to interface between servo processor 126 and hard disk controller 122. Interface processor 124 may perform predictive failure analysis (PFA) algorithms, data recovery procedures, report and log errors, perform rotational positioning ordering (RPO) and perform command queuing. In one example, interface processor may be an ARM processor.

As described above, data is typically written to or read from disk 102 in blocks which are contained within a sector of a particular track. Disk 102 may also include one or more servo sectors within tracks. Servo sectors may be circumferentially or angularly-spaced and may be used to generate servo signals. A servo signal is a signal read from disk 102 that may be used to align slider 106 with a particular sector or track of disk 102. Server processor 126 generally represents the portion of processing unit 120 configured to control the operation of spindle assembly 104 and voice coil motor assembly 110 to insure slider 106 is properly positioned with respect to disk 102. Servo processor 126 may be referred to as a Servo Hardware Assist Real-time Processor (SHARP). Servo processor 126 may be configured to provide closed loop control for any and all combinations of: slider position on track, slider seeking, slider settling, spindle start, and spindle speed. Further, servo processor 126 may include a set of instructions to calculate servo related variables.

For example, a servo signal read from disk 102 may be used by servo processor 126 to determine the amount of displacement of slider 106 from the center of a track. The value of this displacement may be referred to as run out. Run out may include repeatable run out (RRO) caused by spindle assembly or non-repeatable run out (NRRO) caused by internal or external vibrations. Run out is one example of a position accuracy associated with a read or write included in slider 106. If a measured value of NRRO is greater than a predetermined threshold, a write operation may be inhibited. This threshold may be referred to as write inhibit slice (Winh). In addition to servo signals, sensors such as vibration measurement unit 138 may provide information to servo processor 126 and/or processing unit 120 that allow processing unit 120 to calculate a position accuracy value associated with a head of slider 106. Vibration measurement unit 138 may be any device configured to measure vibration of hard disk drive 100 and/or disk 102 and provide a measurement to processing unit 120. In one example, vibration measurement unit 138 may include an accelerometer.

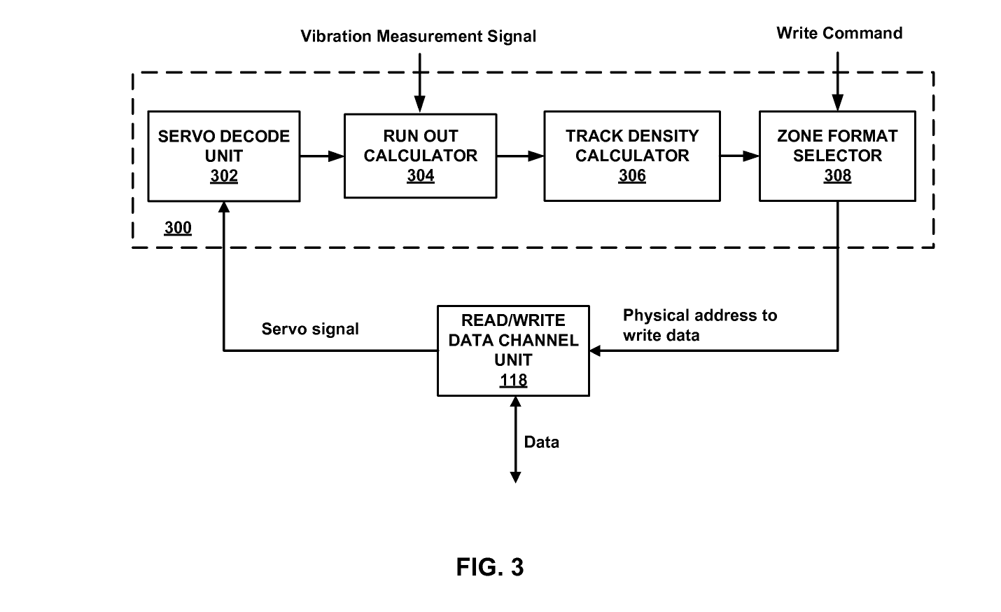

As described above, a position accuracy value associated with a data writing head, e.g., run out, may be used to select one of zone 202, zone 204, and zone 206 of disk 102 to write data to. Further, data may be adaptively written to each of zone 202, zone 204, and zone 206 using respective track densities, track pitches, and/or write inhibit values based on a position accuracy value. FIG. 3 is a block diagram illustrating an example error correction unit that may utilize techniques described in this disclosure.

In the example illustrated in FIG. 3, error correction unit 300 is configured to receive a servo signal and/or a vibration measurement signal and output a physical address in conjunction with receiving a write command. The physical address may correspond to a location of a sector within a zone. As described above, address indirection may be used to map a logical address to a physical address. It should be noted that although error correction unit 300 is illustrated as having distinct functional blocks, such an illustration is for descriptive purposes and does not limit error correction unit 300 to a particular hardware architecture. Functions of error correction unit 300 may be realized using any combination of hardware, firmware and/or software implementations. In one example, error correction unit 300 may be implemented as part of processing unit 120. Further, each component of error correction unit 300 may be included as part of hard disk controller 122, interface processor 124, and/or servo processor 126.

As illustrated in FIG. 3, error correction unit 300 includes servo decode unit 302, run out calculator 304, track density calculator 306, and zone format selector 308. As described above, disk 102 may have servo sectors which may be used to generate servo signals. Servo decode unit 302 may be configured to decode a servo signal read from a disk, such as disk 102, and determine a position of a read head and/or a write head with respect to a track following. As illustrated in FIG. 3, servo decode unit 302 may receive a servo signal from read/write data channel. Run out calculator 304 may be configured to receive a position signal and calculate a run out value for a time window. In one example, a time window may be one second. In other examples, a time window may be greater or less than one second. In addition to or as an alternative to receiving a position signal, run out calculator 304 may be configured to receive a vibration measurement signal and to calculate a run out value based at least in part on the vibration measurement signal. In one example, run out calculator 304 may receive a vibration measurement signal from vibration measurement unit 138. A run out value may be represented as a distance measurement, e.g., nanometers (nm).

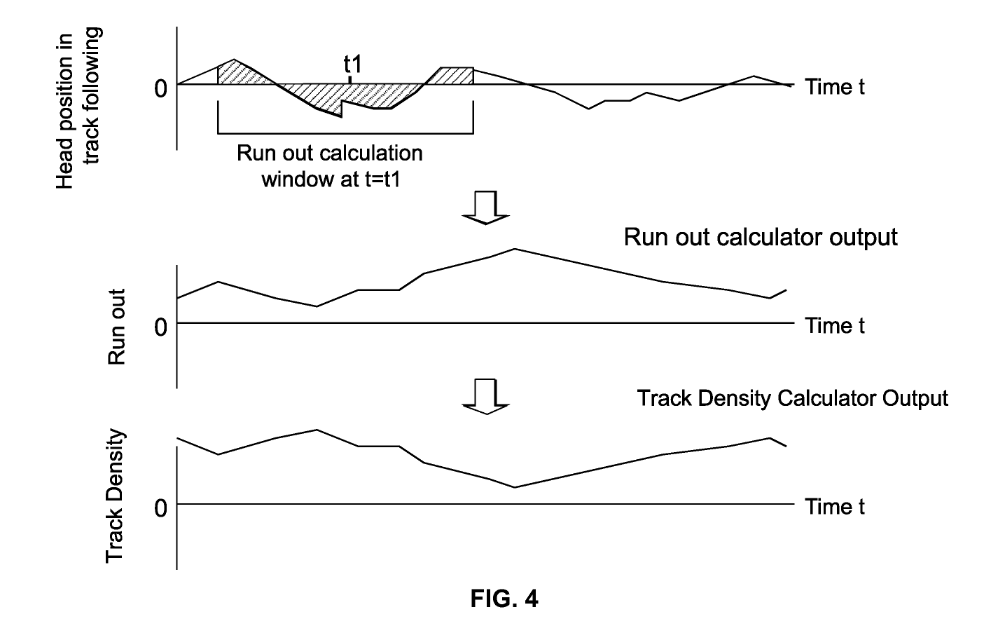

Track density calculator 306 may be configured to receive a run out value and determine a track density. FIG. 4 is a conceptual diagram illustrating one example of determining a track density according to techniques described in this disclosure. As illustrated in FIG. 4, a head position in a track following may be continuously monitored during a time period. Run out calculator 304 may calculate a run out value for a time window, for example time window t₁. In one example, a run out value may be an average run out value for a time window. In other examples, a run out value for a time period may be a high or a low run out value that occurred during the time window. In one example, the run out value for a time window may be calculated according to the following equation:

$$ro ( t ) = \sqrt{{\int }_{t - w}^{t} {hp ( τ )}^{2} d τ} ,$$

where hd(t) is the head position, t is time, and w is the window width.

Track density calculator 306 may calculate a track density based on a received calculated run out value. In one example, the run out value and the calculated track density have an inverse relationship, i.e., as run out increases, the track density decreases. In other examples, the determined run out value and the calculated track density may have a different relationship. For example, the relationship between track density and run may be based on the following equation:

td(t)=25400/(ntp+(ro(t)−nro/C),

where td(t) is the track density in kTPI, ntp is a nominal track pitch in nm, which may be set as a constant value, nro is a nominal run out in nm, which may be set as a constant value, as C is a constant scaling factor.

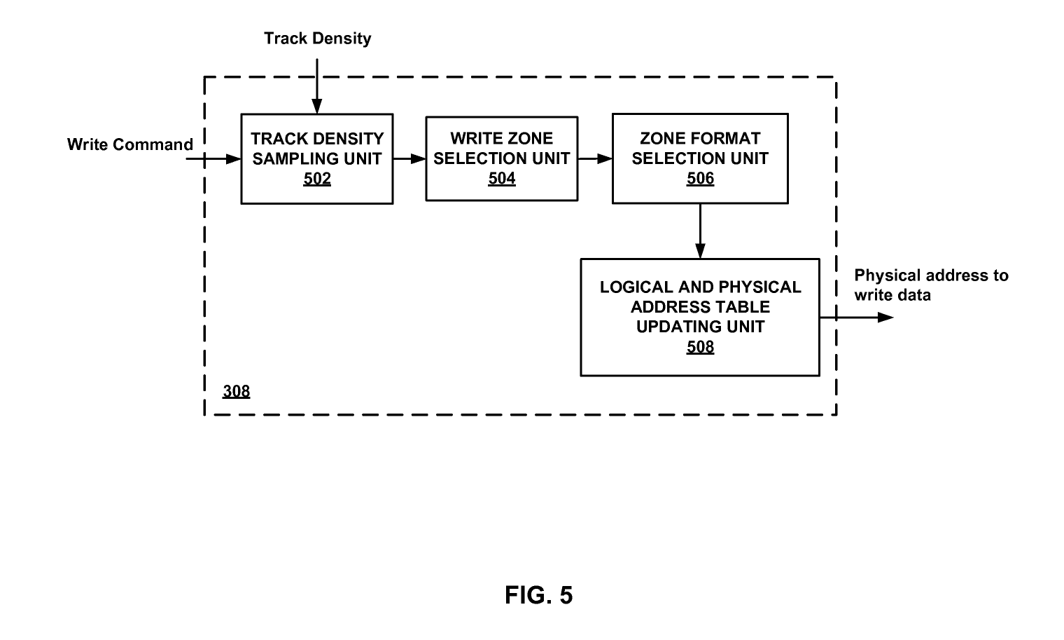

Referring again to FIG. 3, zone format selector 308 may be configured to receive a write command and a track density value and output a physical address to write data. That is, track density calculator 306 and zone format selector 308 may be configured to select a zone to write data to based on a run out value. Further, zone format selector 308 may be configured to select a zone format. As described above, with respect to FIG. 2, a zone format may define one or more of the following: a track density, a track pitch, and/or a write inhibit value. In one example, as illustrated in FIG. 3, zone format selector 308 may be configured to output a physical address to read/write channel unit 118. FIG. 5 is a block diagram illustrating a zone format selector that may utilize techniques described in this disclosure. As illustrated in FIG. 5, zone format selector 308 includes track density sampling unit 502, write zone selection unit 504, zone format selection unit 506, logical and physical address table updating unit 508.

Track density sampling unit 502 may be configured to receive a write command and sample a track density value. A write command may include a data block and an LBA. In one example, track sampling unit 502 is configured to receive a plurality of track density values from track density calculator 306 and sample one or more track density values in conjunction with receiving a write command. The track density calculator output illustrated in graphical form in FIG. 4 represents an example of track density values received by track density sampling unit 502. In one example, track density sampling unit 502 may receive a write command from hard disk controller 122 and sample a track density value at the time the write command is received. A sampled track density value may be expressed as a number of tracks per inch (TPI). In one example, a plurality of sampled track density values may be averaged by track density sampling unit 502 and the averaged value may be output to write zone selection unit 504.

Write zone selection unit 504 may be configured to receive one or more sampled track density values and/or an average track density value and select one of a plurality of zones to write data based on the one or more track density values. In one example, write zone selection unit 504 may select one of a plurality of zones within a buffer area of a disk, e.g., zone 202, zone 204, and zone 206 within an E-region of an SMR disk. In one example, each of zone 202, zone 204, and zone 206 may be configured such that data is written to one of zone 202, zone 204, and zone 206 using a respective track density. For example, zone 202 may be configured such that data is written to zone 202 using a track density of 300,000 tracks per inch (i.e., 300 k TPI), zone 204 may be configured such that data is written to zone 204 using a track density of 325,000 tracks per inch (i.e., 325 k TPI), and zone 206 may be configured such that data is written to zone 206 using a track density of 350,000 tracks per inch (i.e., 350 k TPI). Thus, region R₀ may be configured such that tracks are written at higher densities as the radial distance from the center of disk 102 increases. In another example, region R₀ may be configured such that tracks are written at lower densities as the radial distance from the center of disk 102 increases.

In one example, write zone selection unit 504 may be configured to select a zone such that a data is written to the zone with the highest density that does not exceed the track density. For example, in the case where zone 202 has a track density of 300 k TPI, zone 204 has a track density of 325 k TPI, and zone 206 has a track density of 350 k TPI, and a sampled track density is 340 k TPI, write zone selection unit 504 may be configured to select zone 204. In another example, where zone 202 has a track density of 300 k TPI, zone 204 has a track density of 325 k TPI, and zone 206 has a track density of 350 k TPI, write zone selection unit 504 may be configured to select one of zone 202, zone 204, and zone 206 based on the following run out value ranges: (1) select zone 206 if run out is less than or equal to 1 nm; (2) select zone 204 if run out is greater than 1 nm and less than 2 nm; (3) select zone 202 if run out is greater than or equal to 2 nm. In one example, the run out value used to select one of zone 202, zone 204, and zone 206 may be based on a one second time window occurring immediately before a write command is received. It should be noted that for examples where write zone selection unit 504 selects a zone based on a run out value range, track density calculator 306 may output a track density value such that write zone selection unit 504 selects a desired zone based on a run out range. In this manner, run out calculator 304, track density calculator 306, track density sampling unit 502, and write zone selection unit 504 may be highly integrated.

Zone format selection unit 506 may be configured to format a selected zone. For example, in some cases it may be advantageous to adaptively determine a write inhibit value, a track pitch, and/or a track density for a particular situation. For example, in the example where zone 202 has a track density of 300 k TPI, zone 204 has a track density of 325 k TPI, and zone 206 has a track density of 350 k TPI, after one of zone 202, zone 204, or zone 206 is selected, a write inhibit value may be determined for writing data to the selected zone, where the write inhibit value seeks to accommodate predicted conditions (e.g., vibration conditions) that may occur during a write operation. Further, in some cases, one of zone 202, zone 204, or zone 206 may be full. That is, data capacity of a zone may be used with data that needs to be transferred out of the buffer (e.g., needs to be moved to the I-region).

In this case, an alternative zone may be selected and zone format selection unit 506 may be configured to change the format of the alternative zone that is selected. For example, in the example described above where zone 202 has a track density of 300 k TPI, zone 204 has a track density of 325 k TPI, and zone 206 has a track density of 350 k TPI and an calculated track density is 340 k TPI, if zone 204 is full, write zone selection unit 504 may select zone 206 as an alternative to zone 204 and zone format selection unit 506 may format zone 206 to have the same track density as zone 204 (i.e., 325 k TPI) or, alternatively, format selection unit 506 may format zone 206 to have a track density of 340 k TPI. Further, zone format selection unit 506 may be configured to format zone 202, zone 204, and zone 206 according to any position accuracy conditions (e.g., track densities may be reduced when sustained high levels of vibrations are experienced). In this manner, an initial track density of a zone may be adjusted.

Logical and physical address table updating unit 508 may be configured to receive a selected zone, a zone format, and/or information associated with a write command and output a physical address. In one example, logical and physical address table updating unit 508 may output a physical address to read/write data channel unit 118. Further, logical and physical address table updating unit 508 may be configured to update a logical and physical address table, where a logical and physical address table maps a logical address (e.g., a track number within Zone 202) to a physical address (e.g., a radial distance). As described above, hard disk drive 100 may use address indirection to map logical address to a physical address.

It should be noted that while the above examples describe writing data to a zone based on a position accuracy value associated with a data writing head, the techniques described herein are also applicable to transferring data from an E-region to an I-region. For example, data may be transferring from the E-region to an I-region (e.g., written to the E-region and/or read from the I-region) only when a vibration measurement signal is less than a threshold.

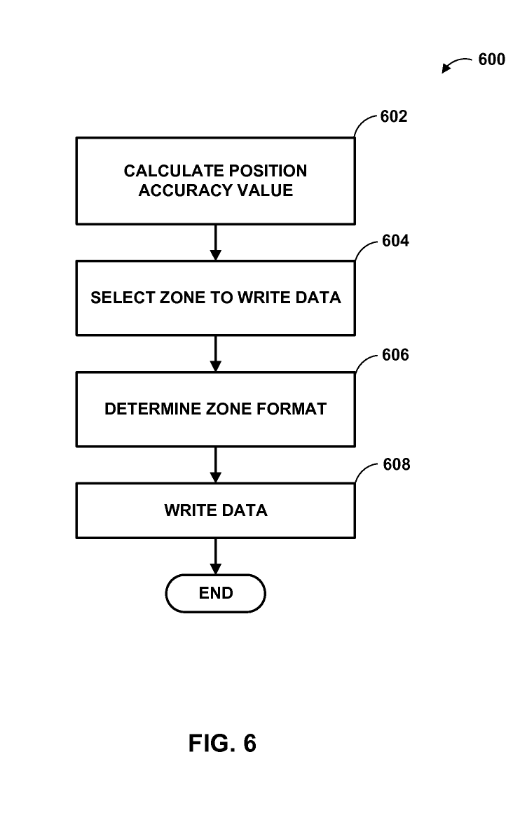

FIG. 6 is a flowchart illustrating an example method for writing data to a magnetic disk according to the techniques of this disclosure. It should be noted that although the method illustrated in FIG. 6 is described as being performed by specific components, this is for illustrative purposes. Method 600 of FIG. 6 may be performed by any and all combinations of components of hard disk drive 100. Run out calculator 304 calculates a position accuracy value associated with a data writing head (602). In one example, a position accuracy value may be a calculated run out value. In another example, a position accuracy value may be a value based on a signal received from a vibration measurement unit, such as vibration measurement unit 138. Zone format selector 308, selects one of a first zone and a second zone of the buffer region based on the position accuracy value (604). For example, zone format selector 308 may select one of zone 202, zone 204, or zone 206 as described above with respect to FIG. 2. Zone format selector 308 determines a zone format for the selected zone (606). A zone format may define one or more of a track density, a track pitch, or a write inhibit value. In some cases, a zone format may be predetermined and determining a zone format for the selected zone may include looking up a predetermined value. In other cases, zone format selector 308, may adaptively determine a zone format as described above. Read/write data channel unit 118 writes data to the selected zone using the determined zone format (608). In this manner, hard disk drive 100 represents an example of a hard disk drive device configured to calculate a position accuracy value associated with a data writing head, select one of a first zone and a second zone of the buffer region based on the position accuracy value, and write data to the selected zone.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structure or any other structure suitable for implementation of the techniques described herein. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Various examples have been described. These and other examples are within the scope of the following claims.

1. A method of writing data to a buffer staging region of a shingled magnetic recording disk, the method comprising:
calculating a position accuracy value associated with a data writing head;
selecting one of a first zone and a second zone of the buffer region based on the position accuracy value, wherein the first zone includes an initial track density that is greater than an initial track density of the second zone; and
writing data to the selected zone of the buffer staging area; and
transferring the written data in the selected zone of the buffer staging area to another area of the magnetic disk.

2. The method of claim 1, wherein calculating the position accuracy value includes calculating a run out value based at least in part on a servo signal.

3. The method of claim 1, wherein calculating the position accuracy value includes determining a vibration measurement based on a signal received from an accelerometer.

4. The method of claim 1, further comprising adjusting the initial track density of the first zone based on the position accuracy value.

5. The method of claim 1, wherein the first zone has an initial track density of 350,000 tracks per inch and the second zone has an initial track density of 325,000 tracks per inch.

6. The method of claim 5, wherein the position accuracy value includes a run out value and wherein selecting one of the first zone and the second zone of the buffer region based on the position accuracy value includes selecting the first zone when the run out value is less than or equal to one nanometer.

7. The method of claim 1, wherein selecting one of a first zone and a second zone based on the position accuracy value includes selecting the zone having the highest density that does not exceed a calculated track density, wherein the position accuracy value is a calculated run out value and the calculated track density is inversely related to the calculated run out value.

8. The method of claim 1, wherein the first zone and the second zone are located on a magnetic disk and the first zone is located at a greater radial distance from a center of the magnetic disk than the second zone.

9. The method of claim 1, wherein the first zone is located on a first magnetic disk and the second zone is located on a second magnetic disk.

10. The method of claim 1, further comprising transferring data written to the selected zone from the selected zone based on the position accuracy value.

11. A hard disk drive device, the device comprising:
a shingled magnetic disk comprising a data buffer staging region including a first zone and a second zone, wherein the first zone has an initial track density that is greater than an initial track density of the second zone; and
a processing unit configured to:
calculate a position accuracy value associated with a data writing head;
select one of a first zone and a second zone of the buffer region based on the position accuracy value; and
write data to the selected zone; and
transfer the written data from the selected zone of the buffer staging area to another area of the magnetic disk.

12. The hard disk drive device of claim 11, wherein calculating the position accuracy value includes calculating a run out value based at least in part on a servo signal.

13. The hard disk drive device of claim 11, wherein calculating the position accuracy value includes determining a vibration measurement based on a signal received from an accelerometer.

14. The hard disk drive device of claim 11, wherein the processing unit is further configured to adjust the initial track density of the first zone based on the position accuracy value.

15. The hard disk drive device of claim 11, wherein the first zone has an initial track density of 350,000 tracks per inch and the second zone has an initial track density of 325,000 tracks per inch.

16. The hard disk drive device of claim 15, wherein the position accuracy value includes a run out value and wherein selecting one of the first zone and the second zone of the buffer region based on the position accuracy value includes selecting the first zone when the run out value is less than or equal to one nanometer.

17. The hard disk drive device of claim 11, wherein selecting one of a first zone and a second zone based on the position accuracy value includes selecting the zone having the highest density that does not exceed a calculated track density, wherein the position accuracy value is a calculated run out value and the calculated track density is inversely related to the calculated run out value.

18. The hard disk drive device of claim 11, wherein the first zone and the second zone are located on a magnetic disk and the first zone is located at a greater radial distance from a center of the magnetic disk than the second zone.

19. The hard disk drive device of claim 11, wherein the first zone is located on a first magnetic disk and the second zone is located on a second magnetic disk.

20. The hard disk drive device of claim 11, wherein the processing unit is further configured to transfer data written to the selected zone from the selected zone based on the position accuracy value.

21. A method of writing data to a buffer region of a shingled magnetic recording disk, the method comprising:
measuring a vibration signal for a data writing head at a time near the writing of data;
calculating a position accuracy value associated with a data writing head based on the measured vibration signal;
selecting one of a first zone and a second zone of the buffer region based on the position accuracy value, wherein the first zone includes an initial track density that is greater than an initial track density of the second zone; and
writing data to the selected zone.

22. The method of claim 21 further comprising measuring a position signal for a data writing head at a time near the writing of data; and
calculating the position accuracy value associated with a data writing head based on a measured position signal and the measured vibration signal.

23. The method of claim 1 further comprising:
measuring a position signal for a disk drive including a data writing head at a time near the writing of data; and
calculating a position accuracy value associated with the data writing head based on the measured position signal.

24. A method of writing data to a buffer staging region of a shingled magnetic recording disk, the method comprising:
measuring a position signal for a data writing head at a time near the writing of data;
calculating a position accuracy value associated with a data writing head based on the measured position signal;
selecting one of a first zone and a second zone of the buffer region based on the position accuracy value, wherein the first zone includes an initial track density that is greater than an initial track density of the second zone; and
writing data to the selected zone of the buffer staging area; and
transferring the written data in the selected zone of the buffer staging area to another area of the magnetic disk.
